(19) United States
(12) Patent Application Publication
(10) Pub. No.: US 2014/0320051 A1
(43) Pub. Date: Oct. 30, 2014

(54) MOTOR WINDING AND POWER ELECTRONIC SWITCH ASSEMBLY HAVING SWITCHABLE OUTPUT CAPABILITY

(71) Applicant: J.D. COMPONENTS CO., LTD., Chang Hua Hsien (TW)

(72) Inventors: Shih-Chieh WANG, Chang Hua Hsien (TW); Yuan-Kuei LEE, Taichung City (TW); Mei-Hao WU, New Taipei City (TW)

(73) Assignee: J.D. COMPONENTS CO., LTD., Chang Hua Hsien (TW)

(21) Appl. No.: 13/870,728

(22) Filed: Apr. 25, 2013

(51) Int. Cl. H02P 6/14

(52) U.S. Cl. CPC H02P 6/14
USPC 318/400.29

(57) ABSTRACT

A motor winding and power electronic switch assembly having switchable output capability is disclosed to include a first winding set including a first upper winding and first lower winding connected to a common contact, a first switch set including four power electronic switches electrically connected to the first winding set, a second winding set including a second upper winding and a second lower winding and connected to the common contact, a second switch set including four power electronic switches electrically connected to the second winding set, a third winding set including a third upper winding and a third lower winding connected to the common contact, a third switch set including four power electronic switches electrically connected to the third winding set, and a configuration control means for controlling on/off of the power electronic switches to form a H type drive configuration or Y type drive configuration.

### BACKGROUND OF THE INVENTION

1. Field of the Invention

The present invention relates to motor driving technology and more particularly, to a motor winding and power electronic switch assembly having switchable output capability.

2. Description of the Related Art

A conventional motor winding assembly is known, as shown in FIG. 9, comprising three Y-connected windings AW,BW,CW corresponding to phases A, B and C, and six power electronic switches T1,T2,T3,T4,T5,T6 respectively switchable on and off to change the current flowing through each of the aforesaid windings, driving the three-phase motor.

However, according to the design of the aforesaid Y-connected motor winding assembly, if you wish to obtain a relatively higher no-load speed during operation of the motor, the starting torque of the motor will be lowered, on the contrary, enabling the motor to provide a relatively higher starting torque, the no-load speed of the motor will be constrained, thus, the motor operational speed range is limited.

Taiwan Patent Publication No. 401923 discloses a technique for switching motor windings between series and parallel configurations. Thus, the motor windings can be switched to the series configuration for low-speed and high-torque application to provide a high torque output. Further, if you wish to increase the speed range after the revolving speed of the motor has been increased, you can switch the motor windings to the parallel configuration to increase the speed range.

Further, Taiwan Patent Publication No. 200538322 discloses another technique for changing the motor driving configuration by using a switching control means to control every switch, determining the number of turns of winding to be connected to the motor.

### SUMMARY OF THE INVENTION

The present invention has been accomplished under the circumstances in view. It is the main object of the present a motor winding and power electronic switch assembly having switchable output capability, which changes the motor driving configuration to increase the working speed range by means of controlling on/off status of every switch.

To achieve this and other objects of the present invention, a motor winding and power electronic switch assembly having switchable output capability comprises a first winding set comprising a first upper winding and a first lower winding, the first upper winding and the first lower winding each having one end thereof connected to a common contact, a first switch set comprising four power electronic switches electrically connected to the first winding set, a second winding set comprising a second upper winding and a second lower winding, the second upper winding and the second lower winding each having one end thereof connected to the common contact, a second switch set comprising four power electronic switches electrically connected to the second winding set, a third winding set comprising a third upper winding and a third lower winding, the third upper winding and the third lower winding each having one end thereof connected to the common contact, a third switch set comprising four power electronic switches electrically connected to the third winding set, and a configuration control means adapted for controlling on/off of the power electronic switches to selectively combine the first winding set, the second winding set and the third winding set into a H type configuration or Y type configuration, achieving the effect of switching output status. The first switch set, the second switch set and the third switch set are electrically connected to a power source and a ground terminal.

Other advantages and features of the present invention will be fully understood by reference to the following specification in conjunction with the accompanying drawings, in which like, reference signs denote like components of structure.

### BRIEF DESCRIPTION OF THE DRAWINGS

FIG. 1 is a circuit diagram of a motor winding and power electronic switch assembly having switchable output capability in accordance with the present invention.

FIG. 2 is a schematic circuit diagram illustrating an operation status of the motor winding and power electronic switch assembly having switchable output capability in accordance with the present invention.

FIG. 3 is an equivalent circuit diagram of the present invention, illustrating a H type configuration operation status of the motor winding and power electronic switch assembly having switchable output capability.

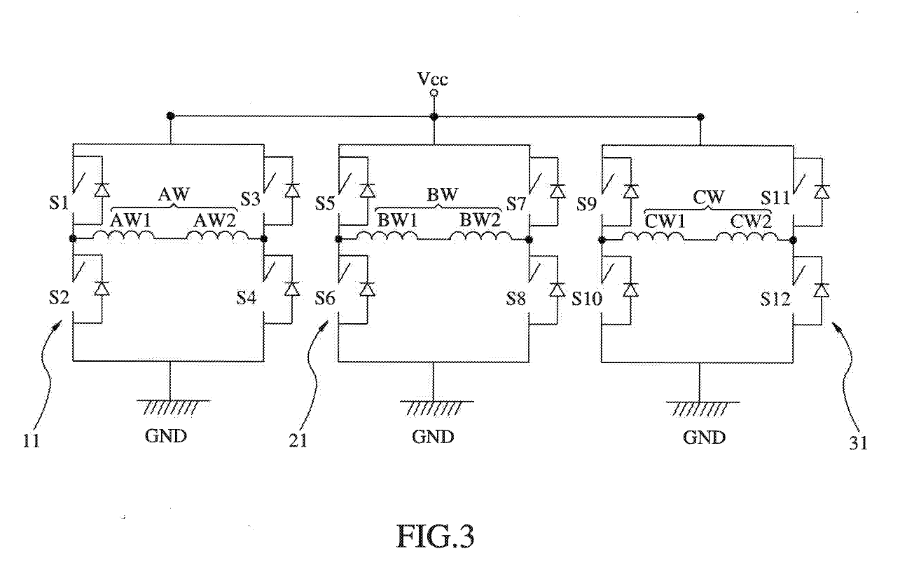

FIG. 4 is a schematic applied view of the present invention, illustrating the flowing direction of current through each winding under a H type six-step square drive configuration.

FIG. 5 is a schematic applied view of the present invention, illustrating the driving architecture under an H type sinusoidal drive configuration.

FIG. 6 is another equivalent circuit diagram of the present invention, illustrating a number of the power electronic switches matched with each upper winding for Y type mode operation.

FIG. 7 is another equivalent circuit diagram of the present invention, illustrating a number of the power electronic switches matched with each lower winding for Y type mode operation.

FIG. 8 is a schematic drawing illustrating the relationship between the motor torque and velocity in accordance with the present invention.

FIG. 9 is a circuit diagram illustrating a motor winding and power electronic switch arrangement according to the prior art.

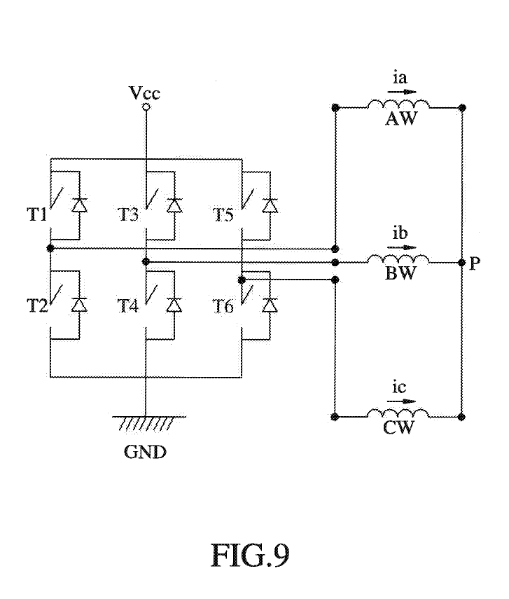

### DETAILED DESCRIPTION OF THE INVENTION

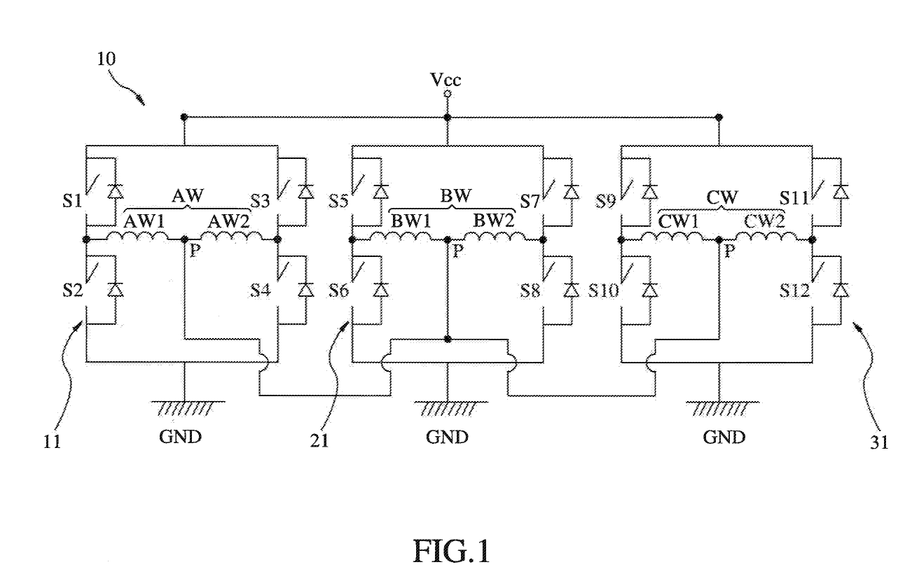

Referring to FIG. 1, a motor winding and power electronic switch assembly having switchable output capability 10 in accordance with the present invention is shown comprising a first winding set AW, a first switch set 11, a second winding set BW, a second switch set 21, a third winding set CW, a third switch set 31, and mode control means (not shown).

The first winding set AW comprises a first upper winding AW1 and a first lower winding AW2. The first upper winding AW1 and the first lower winding AW2 each have one end thereof connected to a common contact P. Further, the first upper winding AW1 and the first lower winding AW2 are symmetrical. In this embodiment, the symmetrical characteristic means that the upper winding and the lower winding have the same number of turns. However, it is still allowable that the windings are configured to have a number of turns approximately similar, i.e., the aforesaid symmetric characteristic is not limited to the condition of having the same number of turns.

The first switch set 11 comprises four power electronic switches electrically connected to the first winding set AW. The four power electronic switches of the first switch set 11 are designated as the first power electronic switch S1, the second power electronic switch S2, the third power electronic switch S3, and the fourth power electronic switch S4. The first power electronic switch S1 and the second power electronic switch S2 are connected in series, and both connected to the first upper winding AW1 to exhibit a Y-connected circuit. The third power electronic switch S3 and the fourth power electronic switch 54 are connected in series, and both connected to the first lower winding AW2 to exhibit a Y-connected circuit.

The second winding set BW comprises a second upper winding BW1 and a second lower winding BW2. The second upper winding BW1 and the second lower winding BW2 each have one end thereof connected to the aforesaid common contact P. Further, the second upper winding BW1 and the second lower winding BW2 are symmetrical. In this embodiment, the symmetrical characteristic means that the upper winding and the lower winding have the same number of turns.

The second switch set 21 comprises four power electronic switches electrically connected to the second winding set BW. The four power electronic switches of the second switch set 21 are designated as the fifth power electronic switch S5, the sixth power electronic switch S6, the seventh power electronic switch S7, and the eighth power electronic switch S8. The fifth power electronic switch S5 and the sixth power electronic switch S6 are connected in series, and both connected to the second upper winding BW1 to exhibit a Y-connected circuit. The seventh power electronic switch S7 and the eighth power electronic switch S8 are connected in series, and both connected to the second lower winding BW2 to exhibit a Y-connected circuit.

The third winding set CW comprises a third upper winding CW1 and a third lower winding CW2. The third upper winding CW1 and the third lower winding CW2 each have one end thereof connected to the aforesaid common contact P. Further, the third upper winding CW1 and the third lower winding CW2 are symmetrical. This symmetrical characteristic, as stated above, is not limited to the condition of having the same number of turns.

The third switch set 31 comprises four power electronic switches electrically connected to the third winding set CW. The four power electronic switches of the second switch set 31 are designated as the ninth power electronic switch S9, the tenth power electronic switch S10, the eleventh power electronic switch S11, and the twelfth power electronic switch S12. The ninth power electronic switch 59 and the tenth power electronic switch S10 are connected in series, and both connected to the third upper winding CW1 to exhibit a Y-connected circuit, The eleventh power electronic switch S11 and the twelfth power electronic switch S12 are connected in series, and both connected to the third lower winding CW2 to exhibit a Y-connected circuit.

The mode control means is adapted for controlling on/off of the power electronic switches to combine the first winding set AW, the second winding set BW and the third winding set CW into an H type mode or Y type mode and to further achieve the desired output status switching effects. This embodiments to cause a synchronized action or complementary action on each power electronic switch S1˜S12 of the first switch set 11, second switch set 21 and third switch set 31. The synchronized action means that the switches of each selected matching pair are synchronously turned on or synchronously turned off. The complementary action means that one switch of each selected matching pair is OFF and the other switch is ON. Further, when each power electronic switch S1˜S12 is ON, a pulse width modulation (PWM) signal is applied to control each power electronic switch S1˜S12, combining the first winding set AW, the second winding set BW and the third winding set CW to form a H type mode or Y type mode.

The first switch set 11, the second switch set 21 and the third switch set 31 are electrically connected to a power source VCC and a ground terminal GND.

If you wish to combine the first winding set AW, the second winding set 11W and the third winding set CW into an H type mode, the operation is outlined hereinafter.

The status of the synchronous action in the mode control means is: the first power electronic switch S1 and the fourth power electronic switch S4 work synchronously; the second power electronic switch S2 and the third power electronic switch S3 work synchronously; the fifth power electronic switch S5 and the eighth power electronic switch S8 work synchronously; the sixth power electronic switch S6 and the seventh power electronic switch S7 work synchronously; the ninth power electronic switch S9 and the twelfth power electronic switch S12 work synchronously; the tenth power electronic switch S10 and the eleventh power electronic switch S11 work synchronously.

The status of the complementary action in the mode control means is; the first power electronic switch S1 and the second power electronic switch S2 work in a complementary manner; the third power electronic switch 53 and the fourth power electronic switch S4 work in a complementary manner; the fifth power electronic switch S5 and the sixth power electronic switch S6 work in a complementary manner; the seventh power electronic switch 57 and the eighth power electronic switch S8 work in a complementary manner; the ninth power electronic switch 59 and the tenth power electronic switch S10 work in a complementary manner; the eleventh power electronic switch S11 the twelfth power electronic switch S12 work in a complementary manner.

Further, the mode control means comprises: terminal voltages or voltage modulation rates for controlling the first switch set 11, the second switch set 21 and the third switch set 31 respectively.

By means of the aforesaid mode control means, the first winding set AW, the second winding set BW and the third winding set CW can be combined to form an H type mode for driving the motor.

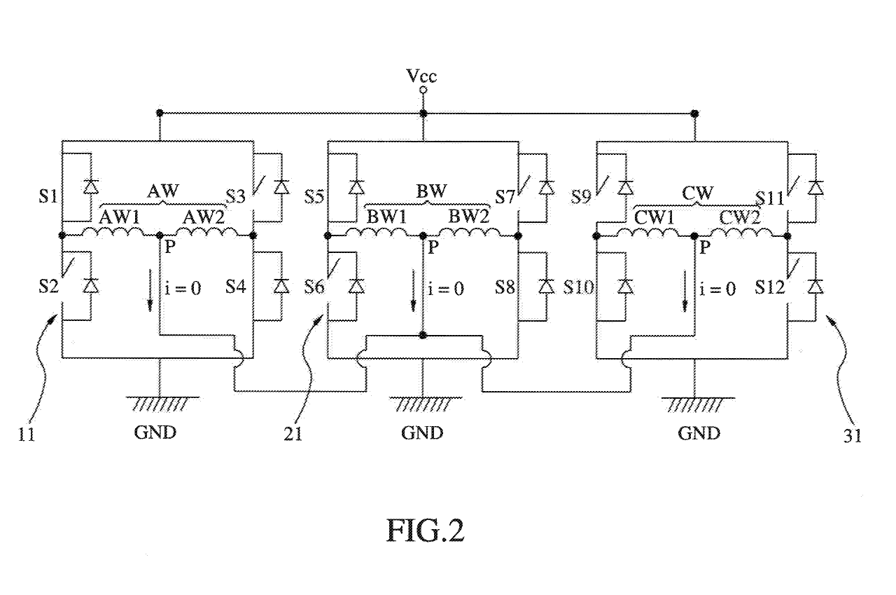

In the H type mode, by means of the symmetrical relationship between the first, second and third upper windings AW1,BW1,CW1 and the first, second and third lower windings AW2,BW2,CW3, the electric current flowing from each winding through the common contact P to the other windings is zero (i=0), as shown in FIG. 2. Thus, the co-relation of the common contact P can be neglected, considering the combination of the winding sets as an H type mode.

If you wish to combine the first winding set AW, the second winding set BW and the third winding set CW into a Y type mode, the operation is outlined hereinafter.

The synchronous action and complementary action in the mode control means are same as the aforesaid H type mode.

However, the mode control means does not control the terminal voltage or voltage modulation rate of the first switch set 11, the second switch set 21 and the third switch set 31 respectively. It employs the known field oriented control (FOC) technique to control the pulse width modulation status of each power electronic switch S1˜S12.

By means of the aforesaid mode control means, the first winding set AW, the second winding set BW and the third winding set CW can be combined to form a Y type configuration for driving the motor, wherein the aforesaid complementary action enables each upper winding to provide an electric current to the other upper windings, or enables each upper winding to provide an electric current to the other lower windings, considering the combination of the winding sets as a Y type configuration. The operation of this Y type configuration will be described latter in conjunction with the annexed drawings.

When assembling the motor, the first winding set AW, the second winding set BW and the third winding set CW are respectively mounted in respective stator grooves. The number of the stator grooves should be a multiple of 3, matching the number of the three upper windings or three lower windings.

Further, in this embodiment, sinusoidal drive configuration or square wave drive configuration is selected for pulse width modulation. If square wave drive configuration is selected, six-step square wave drive configuration can be employed. If sinusoidal drive configuration is selected, sinusoidal pulse width modulation (SPWM) or space vector pulse width module (SVPWM) can be employed.

The following Table I shows an example of the application of six-step square wave drive configuration to drive each power electronic switch. This drive configuration can be used in an H type configuration to drive the motor.

TABLE I

| Status | S1 | S2 | S3 | S4 | S5 | S6 | S7 | S8 | S9 | S10 | S11 | S12 |
|---|---|---|---|---|---|---|---|---|---|---|---|---|
| Status 5 | PWM | OFF | OFF | PWM | OFF | OFF | OFF | OFF | OFF | PWM | PWM | OFF |
| Status 1 | OFF | OFF | OFF | OFF | PWM | OFF | OFF | PWM | OFF | PWM | PWM | OFF |
| Status 3 | OFF | PWM | PWM | OFF | PWM | OFF | OFF | PWM | OFF | OFF | OFF | OFF |
| Status 2 | OFF | PWM | PWM | OFF | OFF | OFF | OFF | OFF | PWM | OFF | OFF | PWM |
| Status 6 | OFF | OFF | OFF | OFF | OFF | PWM | PWM | OFF | PWM | OFF | OFF | PWM |
| Status 4 | OFF | OFF | OFF | PWM | OFF | PWM | PWM | OFF | OFF | OFF | OFF | OFF |

In which: S1 represents the first power electronic switch, S2 represents the second power electronic switch, . . . and so on; PWM represents the power electronic switch is ON and pulse width modulation is performed; OFF represents the power electronic switch is OFF.

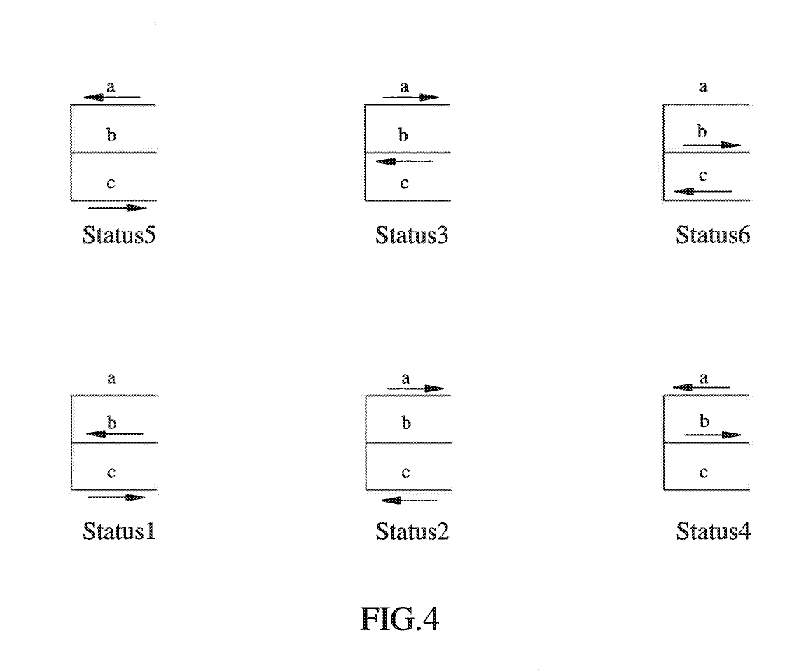

In the case where the first winding set AW is phase A, the second winding set BW is phase B and the third winding set CW is phase C, the drive configuration is illustrated in FIG. 4, in which a,b,c respectively represent the first winding set, the second winding set and the third winding set; the arrowhead sign indicates the direction of the electric current. Thus, the terminal voltage of each switch set 11,21,31 is controlled.

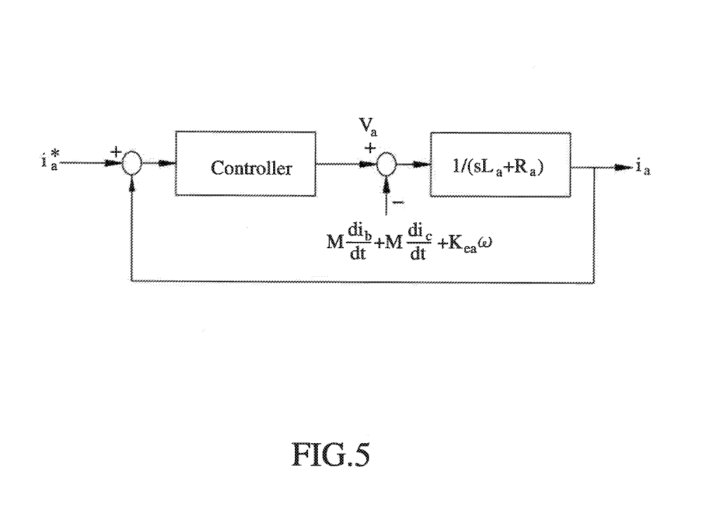

FIG. 5 illustrates a motor drive architecture with the application of a sine wave to drive each switch set 11,21,31. This drive method can be used in an H type drive configuration to drive the motor. In FIG. 5, the corresponding meanings of the respective reference signs are stated in the following Table II.

TABLE II

| | |
|---|---|
| Lₐ | a phase self-inductance |
| M | motor mutual inductance |
| Rₐ | a phase resistance |
| Vₐ | a phase terminal voltage |
| I | phase current pick value |
| ωₑ | motor electrical angular velocity |
| Kₑₐ | a phase motor induced electromotive force constant |
| iₐ* | a phase current command |
| iₐ | a phase current |
| ω | motor mechanical angular velocity |

Normally, the motor mutual inductance (M) is low and can be decoupled, and therefore, control blocks i_{b} and iₜ can be provided, in which:

iₐ*=I sin ωₑt

i_{b}*=I sin(ωₑt−120°)

i_{c}*=I sin(ωₑt−240°).

At this point we can see that the sinusoidal drive method illustrated in FIG. 5 can control the voltage modulation rate of each switch set 11,21,31, obtaining the respective current in phase A, phase B or phase C, achieving the effect of sinusoidal drive mode for H type configuration.

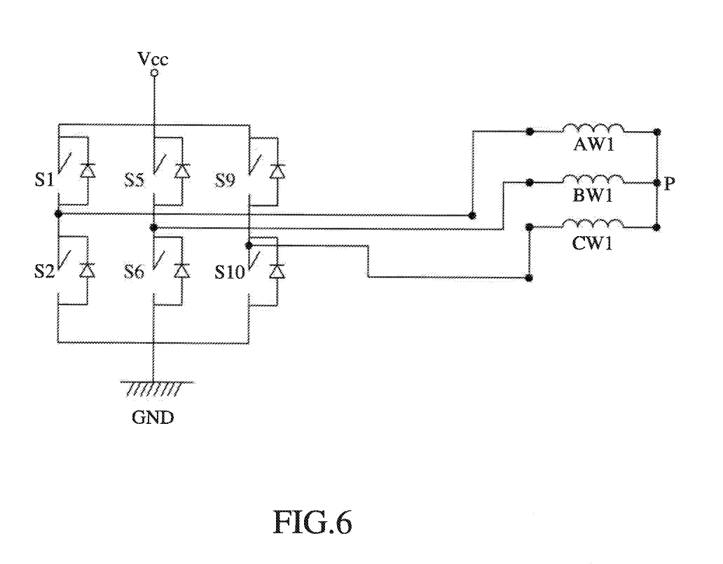

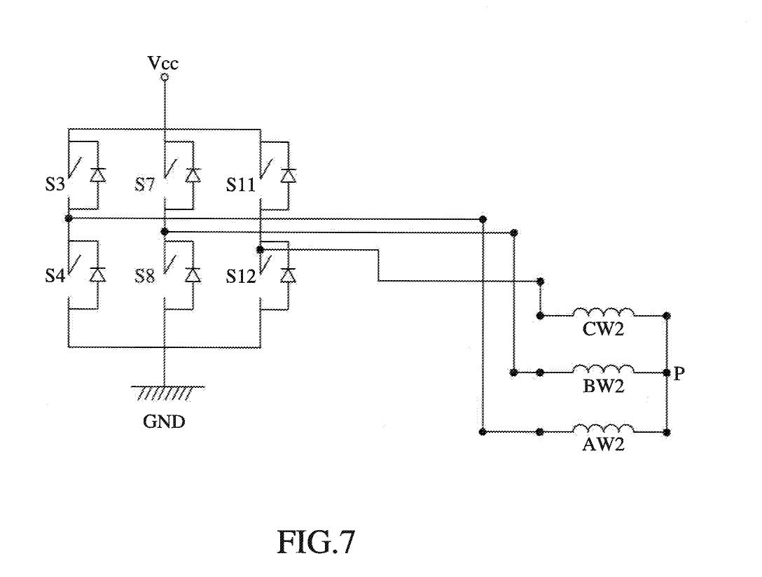

In the case for Y type configuration control, field oriented control (FOC) techniques can be employed to control the pulse width modulation of each power electronic switch. Under the architecture of the first, second, fifth, sixth, ninth and tenth power electronic switches S1,S2,S5,S6,S9,S10, the Y type configuration thus formed is as illustrated in FIG. 6. Under the architecture of the third, fourth, seventh, eighth, eleventh and twelfth power electronic switches S3,S4,S7,S8,S11,S12, the Y type configuration thus formed is as illustrated in FIG. 7. Because the field oriented control (FOC) techniques are of the known art, no further detailed description in this regard will be given.

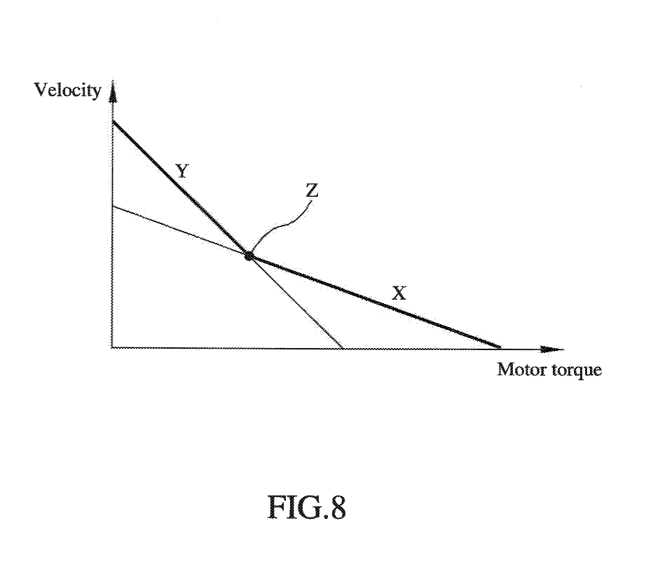

FIG. 8 illustrates the relationship between the motor torque and the velocity, in which: the X curve indicates an H type configuration drive mode practical for high torque and low velocity application; the Y curve indicates a Y type configuration drive mode practical for low torque and high velocity application. Therefore, we can see that using the intersected point Z between the X curve and the Y curve as a switching point between the H type configuration and the Y type configuration allows switching to the Y type configuration drive mode when the velocity surpasses the intersected point Z, or to the H type configuration drive mode when the velocity drops below the intersected point Z, improving the motor driving efficiency and operating speed range.

From the above we can see that the structure of the present invention is totally different from the prior art techniques, it changes the motor drive mode by means of controlling the on/off status of each switch.

What is claimed is:

1. A motor winding and power electronic switch assembly having switchable output capability, comprising:
a first winding set comprising a first upper winding and a first lower winding, said first upper winding and said first lower winding each having one end thereof connected to a common contact;
a first switch set comprising four power electronic switches electrically connected to said first winding set;
a second winding set comprising a second upper winding and a second lower winding, said second upper winding and said second lower winding each having one end thereof connected to said common contact;
a second switch set comprising four power electronic switches electrically connected to said second winding set;
a third winding set comprising a third upper winding and a third lower winding, said third upper winding and said third lower winding each having one end thereof connected to said common contact;
a third switch set comprising four power electronic switches electrically connected to said third winding set; and
a configuration control means adapted for controlling on/off of said power electronic switches to selectively combine said first winding set, said second winding set and said third winding set into a H type configuration or Y type configuration, achieving the effect of switching output status;
said first switch set, said second switch set and said third switch set being electrically connected to a power source and a ground terminal.

2. The motor winding and power electronic switch assembly having switchable output capability as claimed in claim 1, wherein the four power electronic switches of said first switch set are designated as the first power electronic switch, the second power electronic switch, the third power electronic switch and the fourth power electronic switch; the four power electronic switches of said second switch set are designated as the fifth power electronic switch, the sixth power electronic switch, the seventh power electronic switch and the eighth power electronic switch; the four power electronic switches of said third switch set are designated as the ninth power electronic switch, the tenth power electronic switch, the eleventh power electronic switch and the twelfth power electronic switch; said first power electronic switch and said second power electronic switch are connected in series, and both connected to said first upper winding to exhibit a Y-connected circuit; said third power electronic switch and said fourth power electronic switch are connected in series, and both connected to said first lower winding to exhibit a Y-connected circuit; the fifth power electronic switch and the sixth power electronic switch are connected in series, and both connected to said second upper winding to exhibit a Y-connected circuit; said seventh power electronic switch and said eighth power electronic switch are connected in series, and both connected to said second lower winding to exhibit a Y-connected circuit; said ninth power electronic switch and said tenth power electronic switch are connected in series, and both connected to said third upper winding to exhibit a Y-connected circuit; said eleventh power electronic switch and said twelfth power electronic switch are connected in series, both connected to said third lower winding to exhibit a Y-connected circuit.

3. The motor winding and power electronic switch assembly having switchable output capability as claimed in claim 2, wherein said configuration control means is configured to enable each selected matching pair of the power electronic switches of said first switch set, said second switch set and said third switch set to perform a synchronous action or complementary action, said synchronous action being to synchronously turn on/off the two power electronic switches of each selected matching pair, said complementary action being to turn on one of the two power electronic switches of each selected matching pair and to turn off the other of the two power electronic switches of each selected matching pair.

4. The motor winding and power electronic switch assembly having switchable output capability as claimed in claim 3, wherein in said configuration control means, when each said power electronic switch is turned on, a pulse width modulation technique is applied to control each said power electronic switch, enabling said first winding set, said second winding set and said third winding set to combine into a H type configuration or Y type configuration.

5. The motor winding and power electronic switch assembly having switchable output capability as claimed in claim 4, wherein enabling said first winding set, said second winding set and said third winding set to be combined into said Y type configuration is achieved using a field oriented control technique to control the pulse width modulation of each said power electronic switch; enabling said first winding set, said second winding set and said third winding set to be combined into said H type configuration is achieved by controlling the terminal voltage or voltage modulation rate of each of said first switch set, said second switch set and said third switch set.

6. The motor winding and power electronic switch assembly having switchable output capability as claimed in claim 1, wherein the number of motor stator grooves for said first upper winding, said first lower winding, said second upper winding, said second lower winding, said third upper winding and said third lower winding is a multiple of 3.

7. The motor winding and power electronic switch assembly having switchable output capability as claimed in claim 6, wherein said pulse width modulation technique is performed using one of sinusoidal drive configuration and square wave drive configuration.

8. The motor winding and power electronic switch assembly having switchable output capability as claimed in claim 1, wherein said first upper winding and said first lower winding are symmetrical; said second upper winding and said second lower winding are symmetrical; said third upper winding and said third lower winding are symmetrical.
